(19) United States
(12) Patent Application Publication
(10) Pub. No.: US 2004/0071083 A1
(43) Pub. Date: Apr. 15, 2004

(54) Method for streaming fine granular scalability coded video over an IP network

(75) Inventors: Qiong Li, Tappan, NY (US); Warner R.Th. Ten Kate, Waalre (NL)

Correspondence Address: Michael E. Marion, c/o Philips Electronics North America Corp., Corporate Intellectual Property, 580 White Plains Road, Tarrytown, NY, 10591, US

(73) Assignee: KONINKLIJKE PHILIPS ELECTRONICS N.V.

(21) Appl. No.: 10/042,762

(22) Filed: Feb. 22, 2002

(51) Int. Cl. H04L 12/26

(52) U.S. Cl. 370/230

(57) ABSTRACT

The present invention is directed to a system and method for delivery of encoding video data over a data network such as an IP network. In addition to having a server capable of sending multiple layers of data into the data network, the system comprises adaptive nodes located intermediate the server and clients located downstream of the adaptive node where these clients may be receivers and/or other adaptive nodes. Receivers and adaptive nodes may be capable of analyzing network capacity by perceiving network congestion conditions of the data network at that device and dynamically changing the channel subscriptions to which the receiver and/or the adaptive node have subscribed based on the perceived network congestion conditions. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### FIELD OF THE INVENTION

The present invention generally relates to video streaming, and more particularly to streaming fine granular coded video over an IP network such as the Internet.

### BACKGROUND OF THE INVENTION

Fine granular scalability (FGS) has been used to compress video for transmission over networks that have a varying bandwidth such as the Internet. FGS structures consist of a base layer coded at a bit-rate R_{BL} and a single fine-granular enhancement layer coded at R_{EL}

Due to the fine granularity of the enhancement layer, an FGS video stream can be transmitted over any network session with an available bandwidth ranging from Bₘᵢₙ=R_{BL} to Bₘₐₓ=R_{BL}+R_{EL}. For example, if the available bandwidth between the transmitter and the receiver is B=R, then the transmitter sends the base-layer at the rate R_{BL} and only a portion of the enhancement layer at the rate Rₑ=R−R_{BL}. Portions of the enhancement layer can be selected in a fine granular manner for transmission. Therefore, the total transmitted bit-rate is R=R_{BL}+Rₑ.

FGS encoding methods have recently been adopted by MPEG-4 as a standard for streaming applications. It is expected that FGS will gradually gain popularity in wireless and heterogeneous network environments due to its high adaptability to unpredictable bandwidth variations. To help make FGS fully successful, a specialized streaming solution that can take advantage of FGS' bandwidth adaptation characteristics is advantageous. Currently, there is no available mature technology for streaming FGS.

In order to utilize adaptation features of FGS, the prior art has proposed selective forwarding of only the number of layers that a given link can manage, i.e. all the layers are delivered along the same multicast distribution tree or sub-trees implicitly defined by the layer subscription status of receivers. Thus, the receivers may implicitly define a multicast distribution tree by expressing internets in receiving flows. In this mode, a receiver then determines if its current level of subscription is too high or too low.

Prior art methods of dealing with adjustable bandwidth suffer from poor scalability. For example, in feedback implosion, as is well known in the art, the prior art end-to-end solutions result in control signals sent from the users back to the source overwhelming the source when a larger number of users join the session at the same time. The source may not have the computing resources to handle these control signals.

Additionally, the prior art exhibits poor intra-session fairness. If a plurality of users share the same bottleneck link, one user's activity may effect the others' bandwidth and, accordingly, the others' perceived video quality.

Prior art methods also exhibit poor response times. Receivers use a “join or leave” multicast group control to adapt receiving rates but these control procedures involve numerous Internet protocols collaborating together to achieve the goal. This may result in a receiver perceiving an unacceptable latency between the time the receiver issues the control command and the time the command is successfully executed.

### SUMMARY OF THE INVENTION

The present invention is directed to a system and method for delivery of encoded video data over an IP network. Referring generally to FIG. 2, in addition to having a server (generally referred to by the numeral 40) capable of sending multiple layers of data into an IP network, the system comprises adaptive nodes (generally referred to by the numeral 50) located downstream of server 40. The adaptive nodes 50 are disposed intermediate server 40 and receivers (generally referred to by the numeral 60) located downstream of the adaptive nodes 50. The receivers 60 and adaptive nodes 50 may be capable of analyzing network capacity by perceiving network congestion conditions of the data network and dynamically changing the channels to which the receiver 60 and/or adaptive node 50 have subscribed based on the perceived network congestion conditions.

The scope of protection is not limited by the summary of an exemplary embodiment set out above, but is only limited by the claims.

### BRIEF DESCRIPTION OF THE DRAWINGS

Referring now to the drawings where like reference numbers represent corresponding parts throughout:

FIG. 1 is a schematic diagram of an exemplary embodiment of the present invention;

FIG. 2 is a schematic diagram of an exemplary embodiment of the present invention in tree form;

FIG. 3 is schematic diagram of channels as used herein;

FIG. 4 is a further diagrammatic view of channels; and

FIG. 5 and FIG. 6 are block diagrams of an exemplary method of the present invention.

### DETAILED DESCRIPTION OF AN EXEMPLARY EMBODIMENT

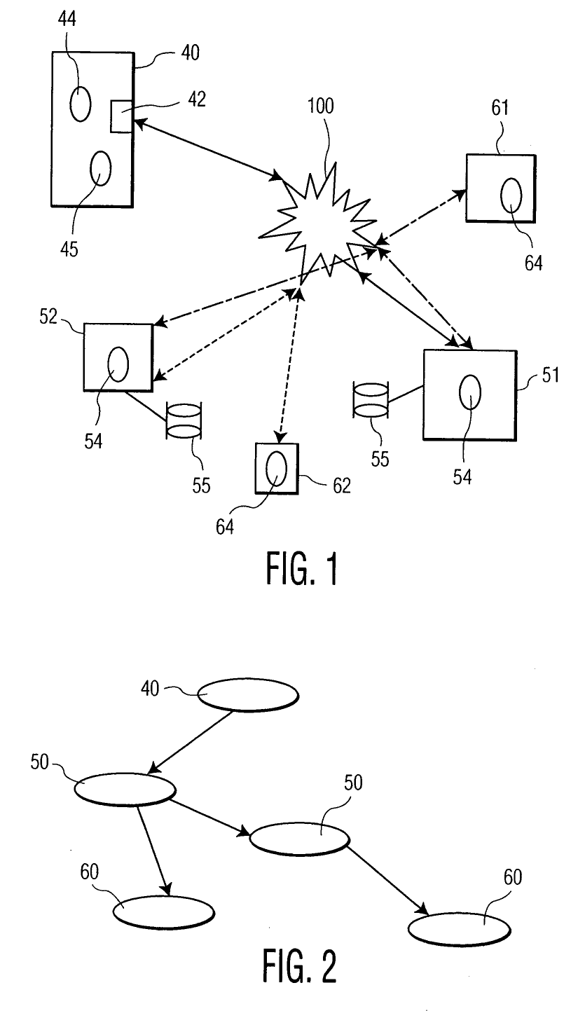

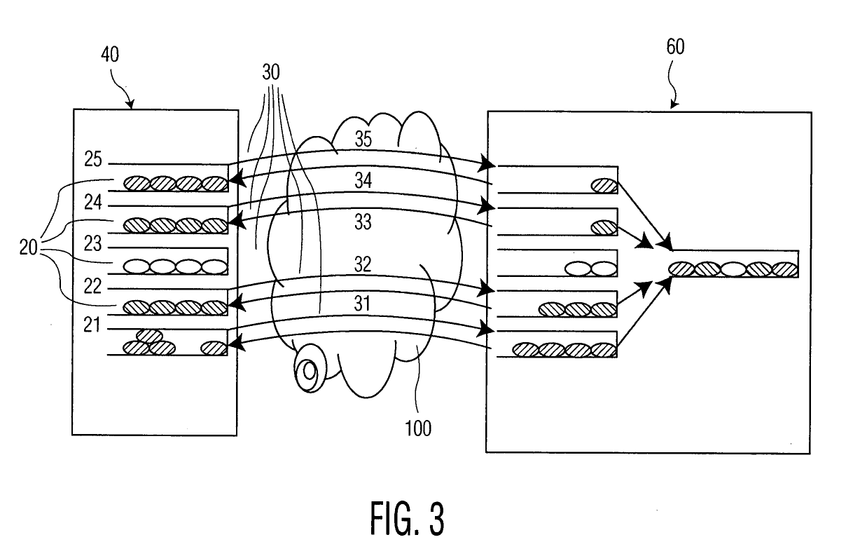

Referring now to the drawings and initially to FIGS. 1 and 3, fine granular scalability (FGS) encoding is implemented to improve the video quality or Signal-to-Noise-Ratio (SNR) of every frame or picture transmitted at FGS base layer 21 (FIG. 3). The present invention provides a channel management model and rate-control mechanism for streaming FGS encoded video over data network 100 by introducing specialized adaptive nodes 51,52 (FIG. 1) disposed in the data stream to achieve scalability and allow embodiments to be deployed directly on top of a standard IP network such as data network 100.

In an exemplary embodiment, as collectively shown in a specific physical schematic layout in FIG. 1 and in a more general, equivalent, logical tree layout in FIG. 2, the present invention comprises a system for encoding and delivering encoded video data that is sensitive to network capacity. The system comprises a server 40, adaptive nodes (generally denoted by numeral 50 in FIG. 2 and specifically by numerals 51 and 52 in FIG. 1), and receivers (generally denoted by numeral 60 in FIG. 2 and specifically by numerals 61 and 62 in FIG. 1), all of which are operatively interconnected via an IP network such as the Internet 100.

As shown in FIGS. 1 and 3, server 40 has a processor and a memory, and is capable of sending data via a data communications device 42 (FIG. 1) into network 100 via multiple channels 30 (FIG. 3). The data comprise a plurality of layers 20 (FIG. 3) such as FGS base layer 21 and a plurality of enhancement video layers 22-25. Base layer encoder 44 (FIG. 1), which may be implemented as software, may be present and executing within server 40 where base layer encoder 44 is capable of encoding a portion of video data to produce a base layer frame. This may include encoding that adheres to standards such as the MPEG-4 standard. Additionally, enhancement layer encoder 45 (FIG. 1), which may be implemented as software, may be executing within server 40 where enhancement layer encoder 45 is capable of generating motion compensated residual image frames from video data and base layer frames using an FGS coding technique.

As shown in FIG. 2, adaptive node 50 is operatively disposed intermediate server 40 and downstream clients such as receiver 60 and/or other adaptive nodes 50, e.g. in FIG. 1 adaptive node 52 is a client of adaptive node 51. Adaptive node 50 is capable of forwarding channels 30 (shown in FIG. 3) subscribed to by a receiver 60 to that receiver 60.

As indicated in FIG. 1 and FIG. 2, a plurality of adaptive nodes 50 may be present, some upstream from other peers such as other adaptive nodes 50, e.g. in FIG. 1 adaptive node 51 is logically upstream from adaptive node 52, and some having downstream peers such as a plurality of downstream receivers 60. As shown additionally in FIG. 2, adaptive node 50 sits logically intermediate server 40 and other adaptive nodes 50, receivers 60, or a combination thereof. Adaptive node 50 (adaptive node 51 in FIG. 1) comprises network analyzer 54, which may be software executing within adaptive node 50. In one embodiment of the invention, the network analyzer's 54 only function may be to account for the number of channels 30 to which each of its downstream receivers 60 has subscribed. In another embodiment of the invention, the network analyzer 54, in addition to accounting for the number of channels subscribed to by each of the downstream receivers 60, may also perceive network congestion conditions at adaptive node 50. Based on the perceived network congestion conditions at the adaptive node 50, the adaptive node 50 dynamically modifies the transmission of channels 30 (FIG. 3) subscribed to by receiver 60.

Adaptive node 50 may perform two different functions. On a forward direction, i.e., from server 40 to receiver 60, adaptive node 50 may enhance network 100 to provide a desired quality of service with respect to a streaming application. In the reverse direction, adaptive node 50 may serve as a control agent that can suppress feedback implosion and speed up channel adaptation controls. Accordingly, adaptive node 50 may also handle channel subscription requests of one or more clients located downstream of that adaptive node 50, i.e. one or more receivers 60 as well as from one or more other adaptive nodes 50 located downstream. Subscription requests may therefore be handled by an adaptive node 50 or by server 40 at the end of back propagation.

Adaptive node 50 may further comprise data store 55 for buffering layers 20 (FIG. 3). Data store 55 may comprise one or more of fixed or removable magnetic media, fixed or removable optical media, and fixed or removable electronic media.

Adaptive nodes 50 and a data sender, e.g. server 40 or another adaptive node 50, may either activate or deactivate a given channel 30, e.g. channels 31-35 shown in FIG. 3, based on received control signals to achieve channel subscription or unsubscription for receivers 60.

Receiver 60 is agnostic of the channel structure. Receiver 60 decodes packets received and outputs them to a presentation system, e.g. to a display monitor or television (not shown in the figures). Network analyzer 64 (FIG. 1), which may be implemented as software executing within receiver 60, monitors network 100 at receiver 60 for perceived network congestion conditions. Based on the perceived network congestion, receiver 60 dynamically subscribes to a predetermined number of channels 30 by sending control signals (such as by using Real-Time Streaming Protocol (RTSP) methods) to adaptive 50 nodes, or directly to the data sender, e.g. server 40.

Adaptive node 50 may receive a subscription from downstream a client, e.g. receiver 60 or another adaptive node 50. Adaptive node 50 may then forward the subscription upstream. Additionally, a subscription message comprising a predetermined number of subscriptions received from all downstream nodes 50,60 may be back-propagated upstream. Adaptive node 50 may also observe the downstream link load, e.g. through packet loss and jitter reports, and decide to reduce its forwarding rate, by way of example and not limitation by dropping packets such as packets in upper channels 30.

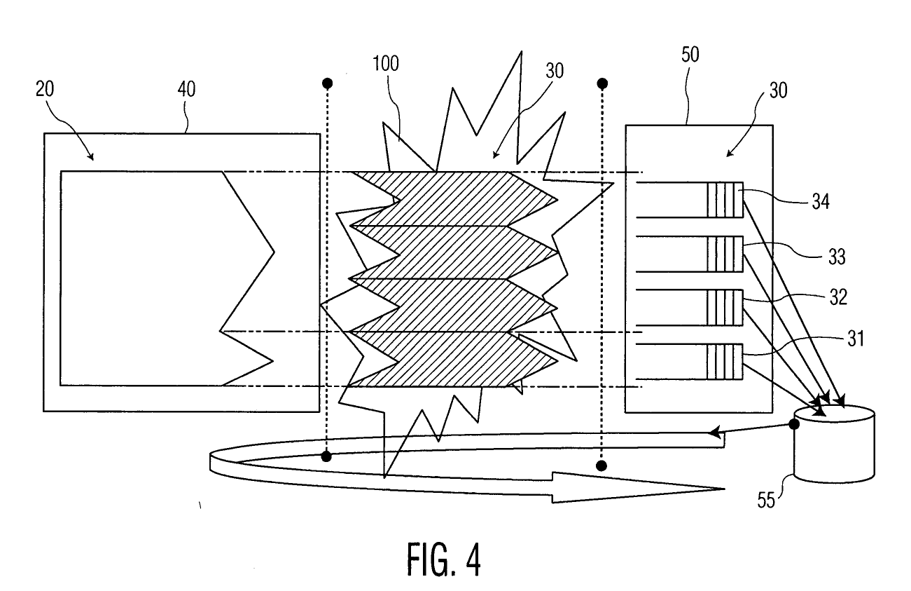

Referring additionally to FIG. 4, adaptive node 50 or server 40 may also schedule the transmission of packets comprising layer data 20 in channels 30, either in burst or regular mode. Packets are forwarded in groups, each group representing one video frame of a group of pictures or frames. In typical situations, the order of group forwarding is prioritized by first transmitting packets containing base layer 21, such that retransmission request 110 has a larger chance of being handled before the presentation deadline of base layer 21 frames. Data store 55 may be used to more rapidly handle retransmission request 110 from receiver 60 (not shown in FIG. 4).

Adaptive node 50 may also raise its own retransmission request 110 upstream for packets lost in the transmission to data store 55. When such a missing packet arrives at adaptive node 50, adaptive node 50 may store the missing packet in data store 55 and additionally may expedite forwarding of the missing packet downstream with or without labeling the missing packet with a priority flag.

Generally in the operation of an exemplary embodiment, a source of video data, e.g. server 40 (FIG. 1), encodes the video data according to FGS standards. Video data may be encoded such as at server 40 (FIG. 1) using FGS techniques wherein a portion of the video data is first used to produce a base layer frame 21 (FIG. 3). Motion compensated residual images are then generated from the video data and base layer frame 21 using a fine granular coding technique. Enhancement layers 22-25 (FIG. 3) are then generated using the motion compensated residual images where each enhancement layer 22-25 comprises at portion of the motion compensated residual images. Server 40 sends a plurality of packets via a plurality of channels 30 to stream FGS coded video over network 100. Receivers 60 (FIG. 1) subscribe to one or more channels 30, depending at least partially on the bandwidth perceived at receiver 60.

In a preferred mode, server 40 assigns a highest delivery priority for packets comprising base layer 21 and progressively decreases priorities for packets from different enhancement layers 22-25 or channels 32-35 for enhancement layers 22-25. For example, when an adaptive node 50 needs to drop a packet, in a preferred mode it will choose from the those with the lowest priority.

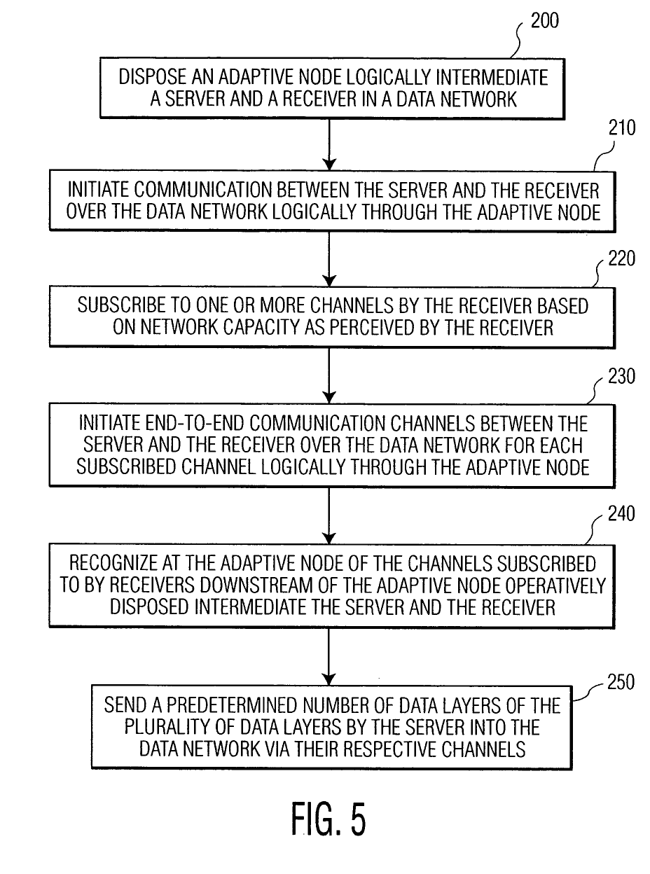

Referring now additionally to FIG. 5, at step 200, one or more adaptive nodes 50 are logically disposed intermediate server 40 and receiver 60 in a data network, e.g. 100. After FGS processing, server 40 may initiate a plurality of end-to-end communication channels 30 between server 40 and one or more downstream receivers 60 by which server 40 provides encoded video to network 100. In a typical embodiment, a predetermined channel, e.g. 31, is associated with base layer 21 with an predetermined bandwidth and priority. Additional channels 30 may be associated with enhancement layers 22-25, e.g. channels 32-35.

Communication between server 40 and receiver 60 is then initiated over data network 100 logically through one or more adaptive nodes 50 at step 210. The receiver 60, at step 220, subscribes to one or more channels 30 containing base layer 21 and at least one of the enhancement layers 22-25 based on network capacity as perceived by the receiver 60. The actual subscriptions to channels 30 are based at least in part on network capacity as perceived by receiver 60. Accordingly, during their participation in the FGS stream session, adaptive nodes 50 and receivers 60 continually monitor bandwidth and dynamically adjust channel subscriptions.

At step 230, server 40 and receiver 60 initiate end-to-end communication channels over data network 100 for each subscribed channel 30 logically through one or more adaptive nodes 50 disposed logically between server 40 and receiver 60. At step 240, adaptive node 50 recognizes the channels 30 subscribed to receivers 60 downstream of the adaptive node 50 operatively disposed intermediate server 40 and those receivers 60.

Once channels 30 have been established, server 40 sends a predetermined number of data layers 20 of the plurality of data layers into data network 100 via their respective channels 30, at step 250.

Referring now to FIG. 6, channel control accomplished by receiver 60 allows receiver 60 to join or leave congested multicast groups by subscribing or relinquishing subscriptions to one or more channels 30. At step 260, receiver 60 monitors network capacity at the receiver 60. At step 280, receiver 60 may modify transmission of the subscribed channels 30 at the receiver 60 based on network capacity as perceived by receiver 60, step 280.

In a currently envisioned embodiment, receiver 60 will dynamically setup or tear down end-to-end communication channels 30 between server 40 and receiver 60 based on network congestion conditions perceived at receiver 60. In this way, the overall system comprising server 40, adaptive node 50, and receiver 60 can effectively adapt the transport rate of FGS coded video without relying on a sophisticated truncation algorithm for enhancement layers 22-25 that may be required if everything is sent in a single channel 30, e.g. 31.

At appropriate times, receiver 60 may issue a retransmission request for packets not received. However, before receiver 60 moves to join or leave a multicast group, it may send a control signal to adaptive node 50 upstream of receiver 60, e.g. adaptive node 51 upstream from receiver 61.

With the multi-channel streaming model of the present invention and FGS, server 40 will send the packets through channels 30 at a maximum rate at which at least one receiver 60 is able to accept. Each receiver 60, at step 281, will receive all subscriptions and calculate maximum subscription rate. All other receivers 60 who are only capable of receiving at lower rates will only subscribe to subgroups of the channels 30. Accordingly, although all channels 30 of the same broadcast session will share or partially share the same multicast delivery tree and server 40 may send a data stream at a maximum bandwidth over channels 30, each receiver 60 accepts the data stream at a bandwidth appropriate to that receiver, based on network capacity as perceived by that receiver 60.

Receivers 60, at step 282, may then back-propagate the calculated maximum subscription rate, such as to adaptive node 50 located upstream or server 40 located upstream.

At step 270, while receiver 60 is monitoring bandwidth and receiving data, adaptive node 50 also monitors network capacity but focuses on network capacity at adaptive node 50. Accordingly, adaptive node 50 also receives packets in different channels 30 and forwards them to the next downstream recipient which may include additional adaptive nodes 50 such as adaptive node 52 and receivers 61,62. Based on the network capacity perceived at adaptive node 50, at step 272 adaptive node 50 may modify transmission of the subscribed channels 30 through the adaptive node 50 to the receiver 60 subscribing to those channels 30 based on network capacity as perceived by the adaptive node 50. Thus, adaptive node 50 is able to modify transmission of the channels 30 subscribed to by downstream receivers 60 through adaptive node 50 to those downstream receivers 60, by way of example not limitation such as by priority buffering or packet dropping.

In a currently envisioned embodiment, a most downstream adaptive node 50, e.g. 52, may receive a channel subscription request from receiver 60 immediately downstream from that adaptive node 52, e.g. receiver 62. This most downstream adaptive node 52 then calculates a maximum channel subscription level appropriate at the most downstream adaptive node 52 and propagates this maximum subscription level to the next adaptation node upstream, e.g. adaptive node 51. The process may repeat up to server 40. The result is that along each branch of the multicast tree the maximum number of channels 30 is transmitted that is appropriate for the network load capacity of each branch.

Each adaptive node 50 in the upstream path may also aggregate all the control signals received from their downstream receivers 60 or downstream adaptive nodes 50 and forward the aggregated control signal back to server 40 if necessary. Server 40 may then adjust its broadcast channels 30 according to received control signals that are forwarded by adaptive node 50.

Adaptive node 50 may drop packets if necessary or delay the transmission of packets within certain delay parameters acceptable to receivers 60 in order to smooth out temporary traffic variations. By way of example and not limitation, a forwarding node, e. g. adaptive node 51, may be configured to drop a packet only when the link capacity downstream of adaptive node 51 is saturated by concurrent traffic beyond a predetermined link threshold, e.g. a certain time scale. If the saturation is only temporary, such as may be caused by bursty traffic, the forwarding process maybe temporarily slowed down but the time span to forward the delayed packets may still be maintained at the same duration as the time span in which all channels 30 had arrived.

Adaptive nodes 50 may process data packets in the order of priorities assigned to those data packets. In a preferred embodiment, adaptive node 50 does not forward packets that are in channels 30 higher than its downstream links can consume, i.e. it drops them. The dropped packets may be dropped according to the priorities assigned to those data packets and the upstream node informed accordingly.

In embodiments where adaptive node 50 has a forwarding buffer 55, adaptive node 50 may buffer content from channels 30, allowing adaptive node 50 to react to differing network capacities upstream and downstream. By way of example, if adaptive node 50 has a buffer 55, it can cache packets such that adaptive node 50 can serve downstream retransmission requests from buffer 55. If adaptive node 50 detects it has to drop packets because of overflow in its forwarding buffer 55, it may do so and then accordingly inform upstream nodes, e.g. 51 and 40.

Additionally, adaptive node 50 may request a retransmission of one or more packets independent of any adaptive nodes 50 or receivers 60 downstream from adaptive node 50. Server 40 may then retransmit the requested packets to adaptive node 50. If downstream capacity becomes available, adaptive node 50 can inform its upstream nodes of such additional capacity and request additional channels 30.

Accordingly, adaptive node 50 may request retransmissions from an upstream source, e.g. server 40, and/or also respond to downstream retransmission requests. Further, using its buffering capabilities, adaptive node 50 may be receiving channel data at a first rate from an upstream source of data, e.g. server 40, while propagating channel data at a second rate to a downstream receiver 60 of the data. This may lead to buffer fill/empty operations that can increase the effective end-to-end data rate without overloading respective parts at both sides of adaptive node 50.

By way of further example and not limitation, assume receiver 60 wants to leave channel 35 to which it currently subscribes. Receiver 60 may first send a channel control signal to either adaptive node 50 or server 40. When this control signal eventually reaches server 40, server 40 can immediately stop sending all packets through channel 35 if no other receiver is currently subscribed to channel 35, even if receiver 60 has not been able to successfully leave the multicast group channel through normal procedures. Channel 35 will become quiet immediately, saving network resources.

The capacity of the downstream links into which adaptive node 50 forwards the packets follows as the forwarding rate that satisfies TCP-friendly criteria, by way of example and not limitation, depending on tolerable end-to-end delay, allowing packets from higher channels, e.g. 32-35, to continue to be forwarded while being buffered at the current bottleneck link to accommodate for the temporal congestion at that link. Accordingly, adaptive node 50 may have two different functions: on the forward direction from server 40 to receiver 60, adaptive node 50 may enhance the IP network to provide quality of service (QoS) to a streaming application such as selective packet dropping. In the reverse direction, adaptive node 50 may serve as a control agent that can suppress feedback implosion and speed up channel adaptation controls.

While the present invention has been described above in terms of specific examples, it is to be understood that the invention is not intended to be confined or limited to the examples disclosed herein. For example, the invention is not limited to any specific coding strategy frame type or probability distribution. On the contrary, the present invention is intended to cover various structures and modifications thereof included within the spirit and scope of the appended claims.

What is claimed is:

1) A system for providing streaming fine granular scalability coded video data, comprising:
a server for sending fine granular scalability coded video data into a data network through a plurality of channels;
a receiver having a first network analyzer that perceives network congestion conditions of the data network at the receiver, and dynamically modifies subscriptions to a predetermined number of the plurality of the channels based on the perceived congestion conditions of the data network at the receiver; and
an adaptive node having a second network analyzer that accounts for the number of the channels subscribed to by the receiver.

2) A system of claim 1 wherein the adaptive node further comprises a mass data store capable of buffering data.

3) The system of claim 1 wherein the adaptive node comprises a plurality of adaptive nodes, wherein at least one of the plurality of adaptive nodes is upstream of at least one other of the plurality of adaptive nodes.

4) The system of claim 1 wherein the second network analyzer merges channel control signals received from other receivers and forwards the merged channel control signals to an upstream peer in order to dynamically modify transmission of the subscribed channels to the receiver.

5) The system of claim 4 wherein the upstream peer comprises the server.

6) The system of claim 1 wherein the receiver is a plurality of receivers.

7) A method for streaming fine granular scalability coded video data, comprising:
providing a server for sending fine granular scalability coded video data into a data network through a plurality of channels;
perceiving network congestion conditions of the data network at a receiver;
dynamically modifying subscriptions to a predetermined number of the plurality of the channels based on the perceived congestion conditions of the data network at the receiver;
accounting for the number of the channels subscribed to by the receiver at an adaptive node.

8) A method for transmitting streaming fine granular scalability coded video data, comprising:
a. disposing an adaptive node logically intermediate a server and a receiver in a data network;
b. initiating communication between the server and the receiver over the data network logically through the adaptive node;
c. subscribing to one or more channels by the receiver based on network capacity as perceived by the receiver, each channel corresponding to a predetermined data layer of a plurality of data layers comprising the streaming fine granular scalability coded video data available at the server;
d. initiating end-to-end communication channels between the server and the receiver over the data network for each subscribed channel logically through the adaptive node;
e. recognizing by the adaptive node of the channels subscribed to by receivers downstream of the adaptive node operatively disposed intermediate the server and the receiver;
f. sending a predetermined number of data layers of the plurality of data layers by the server into the data network via their respective channels;
g. monitoring of the network capacity by the receiver at the receiver;
h. monitoring of the network capacity at the adaptive node by the adaptive node;
i. modifying transmission of the subscribed channels at the receiver based on network capacity as perceived by the receiver; and
j. modifying transmission of the subscribed channels through the adaptive node to the receiver based on network capacity as perceived by the adaptive node.

9) The method of claim 8, wherein step (c) further comprises:
a. coding a portion of the streaming fine granular scalability coded video data to produce a base layer frame;
b. generating a motion compensated residual image from the streaming fine granular scalability coded video data and the base layer frame using a fine granular coding technique; and
c. generating an enhancement layer using the motion compensated residual images, the enhancement layer comprising a plurality of layers, each layer comprising at portion of the motion compensated residual images.

10) The method of claim 8 further comprising buffering the base layer frame and the enhancement layer at the adaptive node.

11) The method of claim 9 wherein the buffering further comprises:
a. requesting retransmissions from an upstream node; and
b. responding to retransmission requests from a downstream node.

12) The method of claim 8 further comprising:
a. receiving layer data at a first rate from an upstream source of data; and
b. forwarding the layer data at a second rate to a downstream receiver of the data.

13) The method of claim 8 wherein the adaptive node handles a subscription request of a client disposed logically downstream of the adaptive node.

14) The method of claim 13 wherein the client comprises at least one of a receiver and a second adaptive node.

15) The method of claim 13, wherein the handling comprises:
a. receiving a subscription request from the receiver at the adaptive node;
b. calculating a maximum subscription level by the adaptive node; and
c. propagating the maximum subscription level by the adaptive node to a next peer upstream.

16) An adaptive node for use in a streaming video data system, comprising:
a. a data communications interface for operatively connecting to a data network;
b. a network analyzer for:
i. perceiving network congestion conditions of the data network at the adaptive node; and
ii. based on the perceived network congestion conditions, dynamically modifying transmission of data channels from a source of data channels disposed logically upstream of the adaptive node to a client logically disposed downstream of the adaptive node.

17) The adaptive node of claim 16 further comprising a buffer.

18) The adaptive node of claim 17 wherein the buffer comprises a mass data storage device.

19) The adaptive node of claim 16 wherein the adaptive node is capable of at least one of receiving requests from a downstream receiver, selectively forwarding requests upstream, receiving data from upstream sources, and selectively forwarding data downstream.

20) The adaptive node of claim 16 wherein the client comprises at least one of a receiver and an adaptive node.
